(19) United States
(12) Patent Application Publication
(10) Pub. No.: US 2020/0213847 A1
(43) Pub. Date: Jul. 2, 2020

(54) TRANSMITTING APPARATUS, RECEIVING APPARATUS AND METHOD FOR AUTHENTICATING SIGNAL USING CHANNEL GAIN INFORMATION

(71) Applicant: Gwangju Institute of Science and Technology, Gwangju (KR)

(72) Inventors: Yong Gu LEE, Gwangju (KR); Seung Tae KIM, Gwangju (KR); Eui Seok HWANG, Gwangju (KR)

(21) Appl. No.: 16/559,488

(22) Filed: Sep. 3, 2019

(30) Foreign Application Priority Data
Dec. 27, 2018 (KR) 10-2018-0170267

(51) Int. Cl. H04W 12/06; H04W 12/04; G06N 7/00

(52) U.S. Cl. CPC H04W 12/0609; G06N 7/005; H04W 12/04033

(57) ABSTRACT

A method for authenticating a signal by using channel gain information of a transmitting apparatus and a receiving apparatus for authenticating a signal by using the channel gain information includes: estimating, by the transmitting apparatus, the channel gain information between the transmitting apparatus and the receiving apparatus by using a first signal received from the receiving apparatus; flipping, by the transmitting apparatus, an authentication key pre-shared with the receiving apparatus by using the channel gain information and requesting authentication by transmitting a second signal to respond to the first signal to the receiving apparatus by using a flipped first authentication key; estimating, by the receiving apparatus, the channel gain information by using the second signal received from the transmitting apparatus; and flipping, by the receiving apparatus, the pre-shared authentication key by using the channel gain information and authenticating the transmitting apparatus by using a flipped second authentication key.

### CROSS-REFERENCE TO RELATED APPLICATIONS

This application claims priority to and the benefit of Korean Patent Application No. 10-2018-0170267 filed in the Korean Intellectual Property Office on, Dec. 27, 2018 the entire contents of which are incorporated herein by reference.

### TECHNICAL FIELD

The present invention relates to a signal authenticating technique of a communication system, and more particularly, to a technique for authenticating a physical layer based signal by using channel gain information of a communication system.

### BACKGROUND ART

Authentication is a process by which identity claims are verified. The authentication in wireless communications is a very critical security issue, which may cause economic and social problems if a hacker sends malicious wirelessly signals like a legitimate sender. For example, if the hacker sends the malicious signal to a network of national institutions, such as a power grid, it may cause serious damage (e.g., blackout, etc.). A challenge-response authentication protocol of a higher layer, one of the authentication techniques, has been studied to cope with such attacks. However, the challenge-response authentication protocol may not be suitable for wireless sensor networks or Internet of Things (IoT) due to high complexity and large signaling overhead problems. In addition, as computing power increases due to technical development, security attacks such as acquisition of authentication keys of hackers for authentication of the higher layer are getting stronger.

In order to solve the problem, an authentication protocol of a PHYsical layer Challenge-Response Authentication Mechanism (PHY-CRAM) technique performed by a physical layer is proposed. The PHY Challenge-Response protocols encapsulate the authentication key using reciprocity and randomness characteristics of channel information, and perform authentication by wirelessly transmitting the encapsulated authentication key by a legitimate transceiver. However, the performance and stability of the authentication may vary depending on which channel information is used. The existing PHY Challenge-Response authentication protocols perform the authentication using channel information including phase information of a channel. However, when the authentication key is exposed by a replay attack of a malicious sender, etc., serious authentication performance deterioration may be caused without relation with the channel information.

As the age of 5G arrives, there is a need that the authentication is also changed according to a changing communication system. For example, in the IoT, 1) hardware limitations (a small memory, a small battery capacity, etc.) of a device, 2) a large number of devices, etc., are issues to be considered in the authentication. Although the PHY Challenge-Response authentication protocol has been developed due to the problems, the PHY Challenge-Response authentication protocol has a drawback in that the PHY Challenge-Response authentication protocol is very vulnerable to the replay attack that intercepts the authentication key because the authentication is attempted based on the authentication key.

Meanwhile, Korean Patent Unexamined Publication No. 10-2013-0029103 entitled “Method and Apparatus for binding Subscriber authentication and Device authentication in Communication Systems” discloses a method and an apparatus for safely protecting a device and authenticating a device (e.g., a client device or an access terminal) and a network entity each other by binding a subscriber authentication and a device authentication in order to generate a security key.

### SUMMARY OF THE INVENTION

The present invention has been made in an effort to provide high authentication performance between physical layers by flipping an authentication key by using a gain value of a channel even when the authentication key is exposed to a malicious sender.

The present invention has also been made in an effort to provide high authentication performance by considering hardware limitations and the number of a large number of devices.

An exemplary embodiment of the present invention provides a method for authenticating a signal by using channel gain information of a transmitting apparatus and a receiving apparatus for authenticating a signal by using the channel gain information, which includes: estimating, by the transmitting apparatus, the channel gain information between the transmitting apparatus and the receiving apparatus by using a first signal received from the receiving apparatus; flipping, by the transmitting apparatus, an authentication key pre-shared with the receiving apparatus by using the channel gain information and requesting authentication by transmitting a second signal to respond to the first signal to the receiving apparatus by using a flipped first authentication key; estimating, by the receiving apparatus, the channel gain information by using the second signal received from the transmitting apparatus; and flipping, by the receiving apparatus, the pre-shared authentication key by using the channel gain information and authenticating the transmitting apparatus by using a flipped second authentication key.

In the authenticating of the transmitting apparatus, the transmitting apparatus may be authenticated based on a magnitude of a calculation value calculated by computing the flipped authentication key and the second signal.

In the authenticating of the transmitting apparatus, the transmitting apparatus may be authenticated by comparing the magnitude of the calculation value and a threshold value.

In the authenticating of the transmitting apparatus, the threshold value may be determined by calculating a probability density function for the magnitude of the calculation value.

In the authenticating of the transmitting apparatus, result values of two probability density functions for the magnitude of the comparison value may be calculated based on a condition that the second signal will be a signal by the transmitting apparatus and a condition that the signal for requesting the authentication will be a signal by an attacker.

In the authenticating of the transmitting apparatus, the result values of the two probability density functions may be estimated through a Monte-Carlo simulation based on a Rice distribution.

Another exemplary embodiment of the present invention provides a transmitting apparatus for authenticating a signal by using channel gain information, which includes: a channel gain estimating unit estimating channel gain information for a receiving apparatus by using a first signal received from the receiving apparatus; and an authentication requesting unit flipping an authentication key pre-shared with the receiving apparatus by using the channel gain information and requesting authentication by transmitting a second signal to respond to the first signal to the receiving apparatus by using a flipped authentication key.

Still another exemplary embodiment of the present invention provides a receiving apparatus for authenticating a signal by using channel gain information, which includes: a channel gain estimating unit estimating channel gain information for a transmitting apparatus by using a signal for requesting authentication, which is received from the transmitting apparatus; and an authentication performing unit flipping an authentication key pre-shared with the transmitting apparatus by using the channel gain information and authenticating the transmitting apparatus by using a flipped authentication key.

The authentication performing unit may authenticate the transmitting apparatus based on a magnitude of a calculation value calculated by computing the flipped authentication key and a signal for requesting the authentication.

The authentication performing unit may authenticate the transmitting apparatus by comparing the magnitude of the calculation value and a threshold value.

The authentication performing unit may determine the threshold value by calculating a probability density function for the magnitude of the calculation value.

The authentication performing unit may calculate result values of two probability density functions for the magnitude of the comparison value based on a condition that the signal for requesting the authentication will be a signal by the transmitting apparatus and a condition that the signal for requesting the authentication will be a signal by an attacker.

The authentication performing unit may estimate the result values of the two probability density functions through a Monte-Carlo simulation based on a Rice distribution.

According to an exemplary embodiment of the present invention, even when an authentication key is exposed to a malicious sender, high authentication performance can be provided by flipping an authentication key.

According to an exemplary embodiment of the present invention, high authentication performance can be provided by considering hardware limitations and the number of a large number of devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a system for authenticating a signal by using channel gain information according to an exemplary embodiment of the present invention.

FIG. 2 is a block diagram illustrating a transmitting apparatus for authenticating a signal by using channel gain information according to an exemplary embodiment of the present invention.

FIG. 3 is a block diagram illustrating a receiving apparatus for authenticating a signal by using channel gain information according to an exemplary embodiment of the present invention.

FIG. 4 is an operation flowchart illustrating a method for authenticating a signal by using channel gain information according to an exemplary embodiment of the present invention.

FIG. 5 is a sequence diagram illustrating a method for authenticating a signal by using channel gain information according to an exemplary embodiment of the present invention.

FIG. 6 is a graph showing a probability density function for two hypotheses for authenticating a signal by using channel gain information according to an exemplary embodiment of the present invention.

FIG. 7 is a graph showing a signal to noise ratio (SNR) for an authentication error probability for authenticating a signal by using channel gain information according to an exemplary embodiment of the present invention.

FIG. 8 is a diagram illustrating a computer system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention will be described below in detail with reference to the accompanying drawings. Herein, the repeated description and the detailed description of publicly-known function and configuration that may make the gist of the present invention unnecessarily ambiguous will be omitted. Embodiments of the present invention are provided for more completely describing the present invention to those skilled in the art. Accordingly, shapes, sizes, and the like of elements in the drawings may be exaggerated for clearer explanation.

Throughout the specification, unless explicitly described to the contrary, the word “comprise” and variations such as “comprises” or “comprising”, will be understood to imply the inclusion of stated elements but not the exclusion of any other elements.

Hereinafter, exemplary embodiments of the present invention will be described in detail with reference to the accompanying drawings.

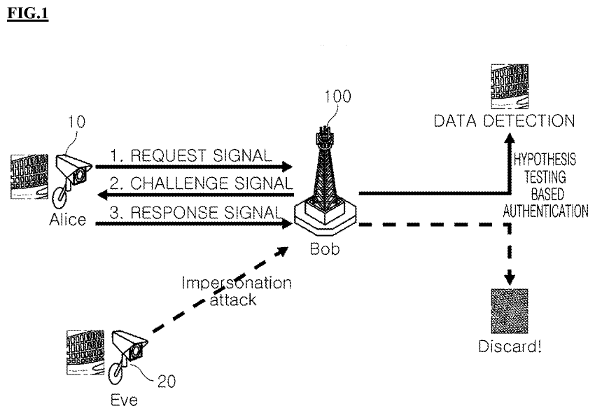

FIG. 1 is a diagram illustrating a system for authenticating a signal by using channel gain information according to an exemplary embodiment of the present invention.

Referring to FIG. 1, a system for authenticating a signal using channel gain information according to an exemplary embodiment of the present invention may be represented by a sender Alice, a receiver Bob, and an attacker Eve.

In this case, the system illustrated in FIG. 1 may correspond to a PHY Challenge-Response authentication system model according to an exemplary embodiment of the present invention.

In this case, the sender Alice may correspond to a transmitting apparatus 10 for authenticating a signal by using channel gain information according to an exemplary embodiment of the present invention.

In this case, the receiver Bob may correspond to a receiving apparatus 100 for authenticating a signal by using channel gain information according to an exemplary embodiment of the present invention.

In this case, the attacker Eve may correspond to a malicious attacker computing apparatus 20 that accesses the receiver Bob by using an exposed authentication key.

First, the system for authenticating a signal using channel gain information according to an exemplary embodiment of the present invention may transmit a Request signal for requesting authentication to a legitimate receiver Bob by a legitimate sender Alice.

In this case, the receiver Bob may transmit a Challenge signal for the Request signal received from the sender Alice and the Alice may respond to a Response signal which may be authenticated by the Bob with an authentication key pre-shared with the Bob.

In the present invention, a PHY Challenge-Response authentication technique may be applied in which M carriers are used and the Alice and the Bob pre-share an authentication key to be used for the authentication.

In this case, the Bob may send to the Alice the Challenge signal shown in Equation 1. Since a purpose of the Challenge signal is channel estimation, the Bob may transmit the signal with phases of all carriers being zero.

$${x}_{A} ( t ) = {\sum }_{i = 1}^{M} \sqrt{\frac{2 {E}_{s}}{T}} cos ( 2 π {f}_{i} t + 0 ) \qquad [ Equation 1 ]$$

Where Eₛ represents energy per symbol and T is a symbol period. In this case, the Alice may receive the signal of Equation 2 as the signal of Equation 1 passes through a channel.

$${u}_{B} ( t ) = {\sum }_{i = 1}^{M} \sqrt{\frac{2 {\vert {h}_{i} \vert}^{2} {E}_{s}}{T}} cos ( 2 π {f}_{i} t + {θ}_{i} ) \qquad [ Equation 2 ]$$

In this case, the Alice may express a BPSK modulation signal acquired by modulating the received Challenge signal as shown in Equation 3.

uᵢ=|hᵢ|e^{jθ}^{ᵢ}+nᵢ, i=1,2, . . . ,M [Equation 3]

In this case, the Alice may estimate channel information between the Alice and the Bob based on the signal of Equation 3. The estimated channel information may be used for encapsulating the authentication key when the Alice sends the Response signal.

That is, the Alice may send the Response signal to the Bob by shifting a pre-shared authentication key K=[κ₁, κ₂, . . . , κ_{M}]T by

$${d}_{i} = \frac{{r}_{i}^{*}}{\vert {r}_{i} \vert} = {e}^{j {\hat{θ}}_{i}} .$$

That is, when the system for authenticating a signal using channel gain information according to an exemplary embodiment of the present invention may secure a strong security by using a fact that a phase of the channel is very sensitive to a distance between the sender and the receiver in the case of using the channel information.

Here, when the authentication is attempted based on the authentication key, in order to supplement a vulnerability in which the authentication key is exposed, the system for authenticating a signal using channel gain information according to an exemplary embodiment of the present invention may flip an authentication key of a specific carrier by using the channel gain information.

In this case, the attacker Eve may not estimate the flipped authentication key in spite of knowing the authentication key as the authentication key is exposed.

A new flipped authentication key may be expressed as shown in Equation 4.

K_{new}=[κ₁α₁,κ₂α₂, . . . ,κ_{M}α_{M}]^{T}

κᵢϵ{−1,1},αᵢϵ{−1,1} |Hᵢ|²<p→αᵢ=−1,

|Hᵢ|²≥p→αᵢ=1 [Equation 4]

In this case, the Alice may express a signal sent to the Bob by using the new flipped authentication key as shown in Equation 5.

$${x}_{B} ( t ) = {\sum }_{i = 1}^{M} \sqrt{\frac{2 {E}_{s}}{T}} cos ( 2 π {f}_{i} t + {ϕ}_{i} - {\hat{θ}}_{i} ) \qquad [ Equation 5 ]$$

In Equation 5, since

$${ϕ}_{i} = \frac{1 - {κ}_{i} {α}_{i}}{2} π , {κ}_{i} {α}_{i} ∈ \{ - 1 , 1 \} ,$$

the signal received by the Bob may be expressed as shown in Equation 6.

$$\begin{matrix}{u}_{{A}_{i}} ( t ) = {\sum }_{i = 1}^{M} \sqrt{\frac{2 {E}_{s}}{T}} \vert {h}_{i} \vert cos ( 2 π {f}_{i} t + ( {ϕ}_{i} - {\hat{θ}}_{i} ) + {θ}_{i} ) \\ = {\sum }_{i = 1}^{M} \sqrt{\frac{2 {E}_{s}}{T}} \vert {h}_{i} \vert cos ( 2 π {f}_{i} t + {ϕ}_{i} + {θ}_{e}^{i} )\end{matrix} \qquad [ Equation 6 ]$$

In Equation 6, since θₑⁱ=θᵢ−\hat{θ}ᵢ, the signal received by the Bob for the response signal may be expressed as shown in Equation 7.

y=\sqrt{Eₛ}·[ρ₁κ₁,ρ₂κ₃, . . . ,ρ_{M}κ_{M}]^{T}+n [Equation 7]

In Equation 7,

$${ρ}_{i} = \vert {h}_{i} \vert {e}^{j {θ}_{e}^{i}} .$$

Due to a randomness characteristic of the channel, if the Eve is not at the same location as the Alice, the Eve will not know the channel between the Alice and the Bob, and as a result, the Eve may not know the channel gain information between the Alice and the Bob. Therefore, the system for authenticating a signal using channel gain information according to an exemplary embodiment of the present invention flips the authentication key using the channel gain information between the Alice and the Bob even if the Eve knows the authentication key to some extent, and as a result, stronger authentication performance may be provided.

In this case, the Bob may verify whether a response signal y comes from the Alice. To this end, the Bob may consider two hypotheses H¹ and H⁰. Here, H₁ may represent a hypothesis that the received signal will be transmitted to the Alice and H₀ may represent a hypothesis that the received signal will be transmitted by the Eve.

In this case, the Bob may determine which one of K_{B} and K_{E} is used as a key used in the Response signal as shown in Equation 8.

H₁:Kₜ=K_{B}

H₀:Kₜ=K_{E} [Equation 8]

In this case, when the Bob receives a probability variable U=u value, the Bob may perform a hypotheses testing of determine any one of the two hypotheses H₁ and H₀.

In this case, U=(Y, K). In this case, Y may represent a probability variable of the signal received by the Bob and K may represent the authentication key shared by the Bob and the Alice.

That is, it can be seen that in both cases, K=K_{B}. When the Alice responds to the Challenge signal of the Bob, (y, K_{B}) may be obtained according to a joint probability distribution p(Y, K) having y dependent on K and when the Eve responds to the Challenge signal of the Bob, the Eve does not know an authentication key K_{B}, so that (y, K_{B}) depending on p(Y)Pr(K) may be obtained. However, since the Bob has a limitation in solving a binary hypotheses testing problem, a test statistic and a hypotheses testing as in Equation 9 may be considered.

η=K_{B}^{Y}y

ζ=|η| [Equation 9]

In this case, the Bob determines threshold τ appropriate to ζ of Equation 9 to make a final determination for authentication of the Response signal.

In this case, the Bob may perform statistical hypotheses testing of determining Eve when ζ|η| is smaller than τ and Bob when ζ=|η| is larger than τ as shown in Equation 10.

$$Ϛ {⋛}_{{H}_{0}}^{{H}_{1}} τ \qquad [ Equation 10 ]$$

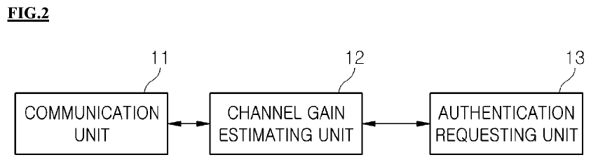

FIG. 2 is a block diagram illustrating a transmitting apparatus for authenticating a signal by using channel gain information according to an exemplary embodiment of the present invention.

Referring to FIG. 2, a transmitting apparatus 10 for authenticating a signal using channel gain information according to an exemplary embodiment of the present invention includes a communication unit 11, a channel gain estimating unit 12, and an authentication requesting unit 13.

The communication unit 11 may transmit a signal to the receiving apparatus 100 and receive the signal from the receiving apparatus 100.

In this case, the communication unit 11 may transmit/receive a Request signal, a Challenge signal, and a Response signal to/from the receiving apparatus 100.

The channel gain estimating unit 12 may estimate the channel gain information for the receiving apparatus 100 using the Challenge signal received from the receiving apparatus 100.

In this case, the channel gain estimating unit 120 may transmit the Request signal for requesting the authentication to receive the Challenge signal from the receiving apparatus 100.

In this case, the channel gain estimating unit 120 may receive the Challenge signal shown in Equation 2 while the Challenge signal shown in Equation 1 transmitted by the receiving apparatus 100 passes through the channel.

In this case, the channel gain estimating unit 120 may estimate the channel gain information by using the BPSK modulation signal acquired by modulating the received Challenge signal as shown in Equation 3.

The authentication requesting unit 130 may flip the authentication key pre-shared with the receiving apparatus 100 by using the channel gain information.

In this case, the authentication requesting unit 130 may flip the pre-shared authentication key by using the channel gain information as shown in Equation 4.

In this case, the authentication requesting unit 130 may request the authentication by transmitting the Response signal to respond to the Challenge signal to the receiving apparatus 100 by using the flipped authentication key.

In this case, the authentication requesting unit 130 may transmit to the receiving apparatus 100 the Response signal generated by using a new flipped authentication key as shown in Equation 5.

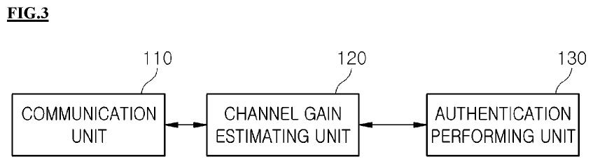

FIG. 3 is a block diagram illustrating a receiving apparatus for authenticating a signal by using channel gain information according to an exemplary embodiment of the present invention.

Referring to FIG. 3, a receiving apparatus for authenticating a signal using channel gain information according to an exemplary embodiment of the present invention includes a communication unit 110, a channel gain estimating unit 120, and an authentication performing unit 130.

The communication unit 110 may transmit the signal to the transmitting apparatus 10 and receive the signal from the transmitting apparatus 10.

In this case, the communication unit 110 may transmit/receive the Request signal, the Challenge signal, and the Response signal to/from the transmitting apparatus 10.

The channel gain estimating unit 120 may estimate the channel gain information for the transmitting apparatus 10 using the Response signal for requesting the authentication received from the transmitting apparatus 10.

In this case, when receiving the Request signal from the transmitting apparatus 10, the channel gain estimating unit 120 may transmit the Challenge signal for the received Request signal to the transmitting apparatus 10.

In this case, the channel gain estimating unit 120 may transmit the Challenge signal shown in Equation 1 to the transmitting apparatus 10.

In this case, the channel gain estimating unit 120 may receive the Response signal shown in Equation 7, which is generated by flipping the authentication key pre-shared by the transmitting apparatus 10.

In this case, the channel gain estimating unit 120 may estimate the channel gain information from the Response signal.

The authentication performing unit 130 may flip the authentication key pre-shared with the transmitting apparatus 10 by using the channel gain information and authenticate the transmitting apparatus 10 by using the flipped authentication key.

In this case, the authentication performing unit 130 may perform the authentication for the Response signal of the receiving apparatus 10 by using hypothesis testing conditions of Equations 8 and 9.

In this case, the authentication performing unit 130 may authenticate the transmitting apparatus based on a magnitude of a calculation value calculated by computing the flipped authentication key and the signal for requesting the authentication.

In this case, the authentication performing unit 130 may authenticate the transmitting apparatus by comparing the magnitude of the calculated value and a threshold value.

In this case, the authentication performing unit 130 may determine the threshold value by calculating a probability density function for the magnitude of the calculation value.

In this case, the authentication performing unit 130 may calculate result values of two probability density functions for the magnitude of the comparison value based on a condition that the signal for requesting the authentication will be a signal by the transmitting apparatus and a condition that the signal for requesting the authentication is a signal by the attacker.

In this case, the authentication performing unit may estimate the result values of the two probability density functions through a Monte-Carlo simulation based on a Rice distribution.

In this case, the authentication performing unit 130 may perform the statistical hypotheses testing of determining Eve when ζ=|η| is smaller than τ and Bob when ζ=|η| is larger than τ as shown in Equation 10.

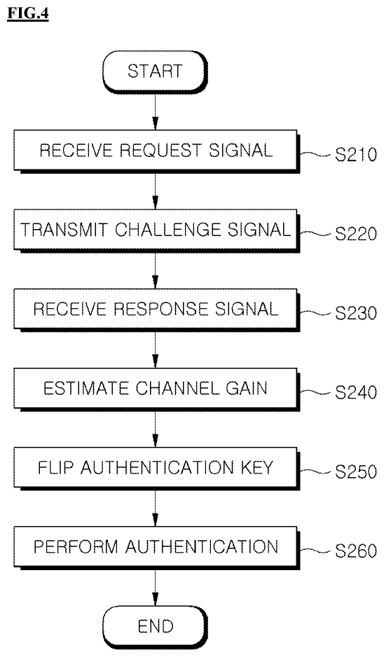

FIG. 4 is an operation flowchart illustrating a method for authenticating a signal by using channel gain information according to an exemplary embodiment of the present invention.

Referring to FIG. 4, a method for authenticating a signal using channel gain information according to an exemplary embodiment of the present invention may first receive a Request signal (S210).

That is, in step S210, the receiving apparatus 100 may receive the Request signal for starting the request for authentication from the transmitting apparatus 10. Further, the method for authenticating a signal using channel gain information according to an exemplary embodiment of the present invention may transmit the Challenge signal (S220).

That is, in step S220, when the receiving apparatus 100 receives the Request signal from the transmitting apparatus 10, the receiving apparatus 100 may transmit the Challenge signal for the received Request signal to the transmitting apparatus 10.

In this case, in step S220, the receiving apparatus 100 may transmit the Challenge signal shown in Equation 1 to the transmitting apparatus 10.

In this case, in step S220, the channel gain information for the receiving apparatus 100 may be estimated by using the Challenge signal which the transmitting apparatus 10 receives from the receiving apparatus 100.

In this case, in step S220, the transmitting apparatus 10 may receive the Challenge signal shown in Equation 2 while the Challenge signal shown in Equation 1 received from the receiving apparatus 100 passes through the channel.

In this case, in step S220, the transmitting apparatus 10 may estimate the channel gain information by using the BPSK modulation signal acquired by modulating the received Challenge signal as shown in Equation 3.

In this case, in step S220, the transmitting apparatus 10 may flip the authentication key pre-shared with the receiving apparatus 100 by using the channel gain information.

In this case, in step S220, the transmitting apparatus 10 may flip the pre-shared authentication key by using the channel gain information as shown in Equation 4.

In the method for authenticating a signal using channel gain information according to an exemplary embodiment of the present invention, the Response signal may be received (S230).

That is, in step S230, the transmitting apparatus 10 may request the authentication by transmitting the Response signal to respond to the Challenge signal to the receiving apparatus 100 by using the flipped authentication key.

In this case, in step S230, the Response signal generated by the new flipped authentication key may be transmitted to the receiving apparatus 100 as shown in Equation 5.

In this case, in step S230, the receiving apparatus 100 may receive the Response signal shown in Equation 7, which is generated by flipping the pre-shared authentication key from the transmitting apparatus 10.

In the method for authenticating a signal using channel gain information according to an exemplary embodiment of the present invention, the channel gain information may be estimated (S240).

That is, in step S240, the receiving apparatus 100 may estimate the channel gain information for the transmitting apparatus 100 by using the Response signal for requesting the authentication received from the transmitting apparatus 10.

In this case, in step S240, the receiving apparatus 100 may estimate the channel gain information from the Response signal.

In the method for authenticating a signal using channel gain information according to an exemplary embodiment of the present invention, the pre-shared authentication key may be flipped (S250).

That is, in step S250, the authentication key pre-shared by the transmitting apparatus 10 may be flipped by using the channel gain information.

In the method for authenticating a signal using channel gain information according to an exemplary embodiment of the present invention, the authentication for the transmitting apparatus 10 may be performed (S260).

That is, in step S260, the receiving apparatus 100 may authenticate the transmitting apparatus 10 by using the flipped authentication key.

In this case, in step S260, the receiving apparatus 100 may perform the authentication for the Response signal of the receiving apparatus 10 by using the hypothesis testing conditions of Equations 8 and 9.

In this case, in step S260, the transmitting apparatus may be authenticated based on a magnitude of a calculation value calculated by computing the flipped authentication key and the signal for requesting the authentication.

In this case, in step S260, the transmitting apparatus may be authenticated by comparing the magnitude of the calculated value and a threshold value.

In this case, in step S260, the threshold value may be determined by calculating a probability density function for the magnitude of the calculation value.

In this case, in step S260, result values of two probability density functions for the magnitude of the comparison value may be calculated based on a condition that the signal for requesting the authentication will be a signal by the transmitting apparatus and a condition that the signal for requesting the authentication is a signal by the attacker.

In this case, in step S260, the result values of the two probability density functions may be estimated through a Monte-Carlo simulation based on a Rice distribution.

For example, in step S260, the receiving apparatus 100 may perform the statistical hypotheses testing of determining Eve when ζ=|η| is smaller than τ and Bob when ζ=|η| is larger than τ as shown in Equation 10.

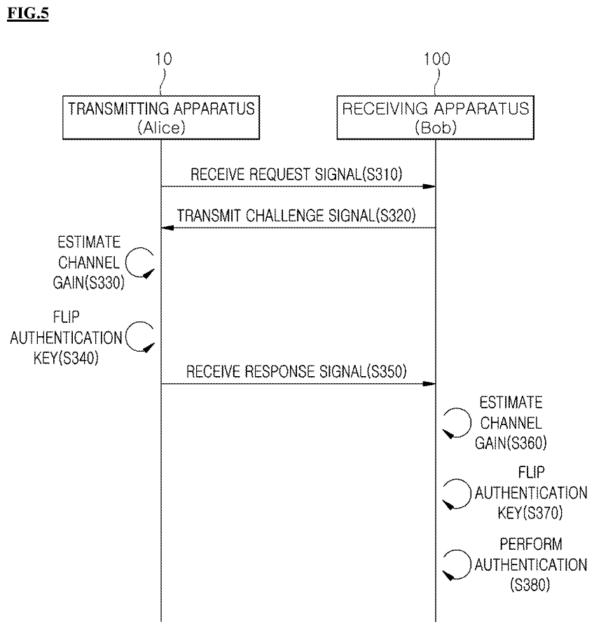

FIG. 5 is a sequence diagram illustrating a method for authenticating a signal by using channel gain information according to an exemplary embodiment of the present invention.

Referring to FIG. 5, in a method for authenticating a signal using channel gain information according to an exemplary embodiment of the present invention, first, a Request signal may be received (S310).

That is, in step S310, the receiving apparatus 100 may receive the Request signal for starting the request for authentication from the transmitting apparatus 10.

The method for authenticating a signal using channel gain information according to an exemplary embodiment of the present invention may transmit the Challenge signal (S320).

That is, in step S320, when the receiving apparatus 100 receives the Request signal from the transmitting apparatus 10, the receiving apparatus 100 may transmit the Challenge signal for the received Request signal to the transmitting apparatus 10.

In this case, in step S320, the receiving apparatus 100 may transmit the Challenge signal shown in Equation 1 to the transmitting apparatus 10.

In the method for authenticating a signal using channel gain information according to an exemplary embodiment of the present invention, the transmitting apparatus 10 may estimate the channel gain information (S330).

In this case, in step S330, the transmitting apparatus 10 may estimate the channel gain information for the receiving apparatus 100 by using the Challenge signal received from the receiving apparatus 100.

In this case, in step S330, the transmitting apparatus 10 may receive the Challenge signal shown in Equation 2 while the Challenge signal shown in Equation 1 received from the receiving apparatus 100 passes through the channel.

In this case, in step S330, the transmitting apparatus 10 may estimate the channel gain information by using the BPSK modulation signal acquired by modulating the received Challenge signal as shown in Equation 3.

In the method for authenticating a signal using channel gain information according to an exemplary embodiment of the present invention, the pre-shared authentication key may be flipped (S340).

That is, in step S340, the transmitting apparatus 10 may flip the authentication key pre-shared by the receiving apparatus 100 by using the channel gain information.

In this case, in step S340, the transmitting apparatus 10 may flip the pre-shared authentication key by using the channel gain information as shown in Equation 4.

In the method for authenticating a signal using channel gain information according to an exemplary embodiment of the present invention, the Response signal may be received (S350).

That is, in step S350, the transmitting apparatus 10 may request the authentication by transmitting the Response signal to respond to the Challenge signal to the receiving apparatus 100 by using the flipped authentication key.

In this case, in step S350, the Response signal generated by the new flipped authentication key may be transmitted to the receiving apparatus 100 as shown in Equation 5.

In this case, in step S350, the receiving apparatus 100 may receive the Response signal shown in Equation 7, which is generated by flipping the pre-shared authentication key from the transmitting apparatus 10.

In the method for authenticating a signal using channel gain information according to an exemplary embodiment of the present invention, the channel gain information may be estimated (S360).

That is, in step S360, the receiving apparatus 100 may estimate the channel gain information for the transmitting apparatus 10 by using the Response signal for requesting the authentication received from the transmitting apparatus 10.

In this case, in step S360, the receiving apparatus 100 may estimate the channel gain information from the Response signal.

In the method for authenticating a signal using channel gain information according to an exemplary embodiment of the present invention, the pre-shared authentication key may be flipped (S370).

That is, in step S370, the authentication key pre-shared by the transmitting apparatus 10 may be flipped by using the channel gain information.

In the method for authenticating a signal using channel gain information according to an exemplary embodiment of the present invention, the authentication for the transmitting apparatus 10 may be performed (S380).

That is, in step S380, the receiving apparatus 100 may authenticate the transmitting apparatus 10 by using the flipped authentication key.

In this case, in step S380, the receiving apparatus 100 may perform the authentication for the Response signal of the receiving apparatus 10 by using the hypotheses testing conditions of Equations 8 and 9.

In this case, in step S380, the transmitting apparatus may be authenticated based on a magnitude of a calculation value calculated by computing the flipped authentication key and the signal for requesting the authentication.

In this case, in step S380, the transmitting apparatus may be authenticated by comparing the magnitude of the calculated value and a threshold value.

In this case, in step S380, the threshold value may be determined by calculating a probability density function for the magnitude of the calculation value.

In this case, in step S380, result values of two probability density functions for the magnitude of the comparison value may be calculated based on a condition that the signal for requesting the authentication will be a signal by the transmitting apparatus and a condition that the signal for requesting the authentication is a signal by the attacker.

In this case, in step S380, the result values of the two probability density functions may be estimated through a Monte-Carlo simulation based on a Rice distribution.

For example, in step S380, the receiving apparatus 100 may perform the statistical hypotheses testing of determining Eve when ζ=|η| is smaller than τ and Bob when ζ=|η| is larger than τ as shown in Equation 10.

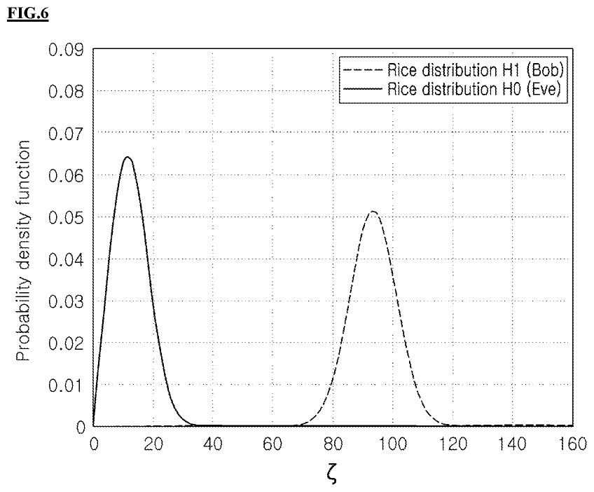

FIG. 6 is a graph showing a probability density function for two hypotheses for authenticating a signal by using channel gain information according to an exemplary embodiment of the present invention.

Referring to FIG. 6, it can be seen that there is shown a result of calculating through a simulation probability density functions for two hypotheses for authenticating a signal by using channel gain information according to an exemplary embodiment of the present invention.

In this case, the number of transmitted carriers may be set to M=128 and a parallel fading channel model may be assumed for multi-channel transmission. Under two hypotheses Hᵢ, i=0, 1, a probability density function (pdf) of ζ may be investigated.

In this case, τ may be appropriately determined based on the pdf of ζ.

In this case, both ζ|H₁ and ζ|H₀ may follow the Rice distribution and |ηᵢ|ₒ τ²H_{P} i=0, 1 may be directly estimated through the Monte-Carlo simulation.

As illustrated in FIG. 6, when a pre-shared authentication key K is exposed at 80%, it can be seen that the pdfs ζ|H₁ of and ζ|H₀ are shown by the method proposed by the present invention. It can be seen that there is a considerable difference between and the pdfs of ζ|H₁ and ζ|H₀ when τ is appropriately selected based on the pdf of ζ authentication performance may be provided, to easily distinguish Eve and Alice.

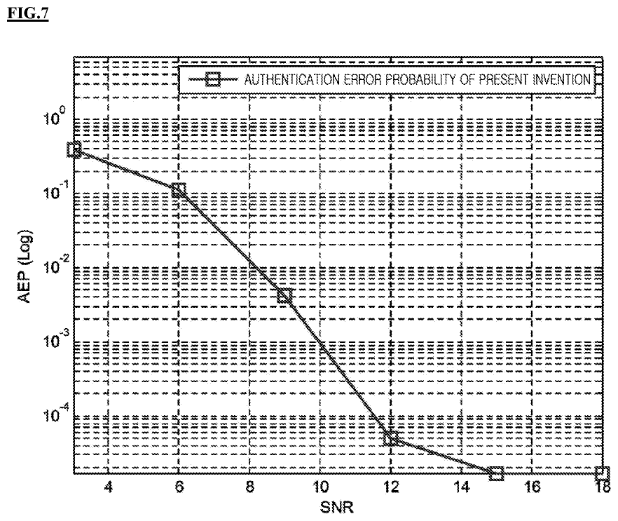

FIG. 7 is a graph showing a signal to noise ratio (SNR) for an authentication error probability for authenticating a signal by using channel gain information according to an exemplary embodiment of the present invention.

Referring to FIG. 7, in the process of authenticating a signal according to an exemplary embodiment of the present invention, it can be seen that an authentication error probability according to a signal to noise ratio (SNR) has good authentication performance in a reasonable SNR environment (e.g., 12 dB).

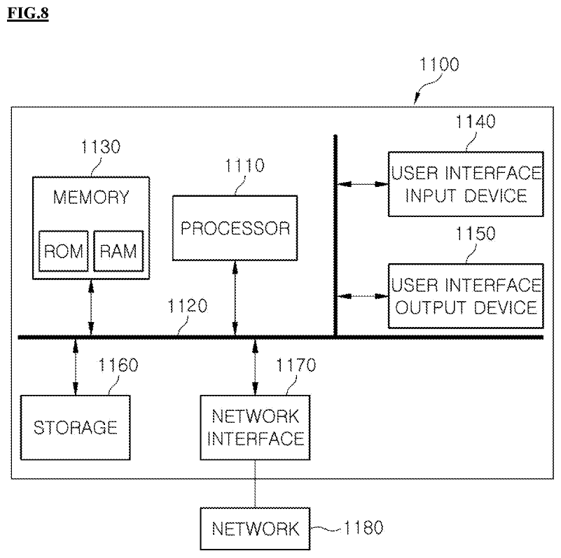

FIG. 8 is a diagram illustrating a computer system according to an exemplary embodiment of the present invention.

Referring to FIG. 8, a transmitting apparatus 10 and a receiving apparatus 100 for authenticating a signal using channel gain information according to an exemplary embodiment of the present invention may be implemented in a computer system 1100 such as a computer readable recording medium. As illustrated in FIG. 8, the computer system 1100 may include one or more processors 1110, a memory 1130, a user interface input device 1140, a user interface output device 1150, and a storage 1160 which communicate with each other through a bus 1120. In addition, the computer system 1100 may further include a network interface 1170 connected to a network 1180. A processor 1110 may be a central processing unit or a semiconductor device that executes processing instructions stored in the memory 1130 or the storage 1160. The memory 1130 and the storage 1160 may be various types of volatile or non-volatile storage media. For example, the memory may include a ROM 1131 or a RAM 1132.

As described above, the configurations and the methods of the embodiments described above may not be limitedly applied to the transmitting apparatus, the receiving apparatus, and the method for authenticating a signal by using channel gain information according to an exemplary embodiment of the present invention, but the embodiments may be configured by selectively combining all or some of the respective embodiments so as to be variously modified.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for authenticating a signal by using channel gain information of a transmitting apparatus and a receiving apparatus for authenticating a signal by using the channel gain information, the method comprising:
estimating, by the transmitting apparatus, the channel gain information between the transmitting apparatus and the receiving apparatus by using a first signal received from the receiving apparatus;
flipping, by the transmitting apparatus, an authentication key pre-shared with the receiving apparatus by using the channel gain information and requesting authentication by transmitting a second signal to respond to the first signal to the receiving apparatus by using a flipped first authentication key;
estimating, by the receiving apparatus, the channel gain information by using the second signal received from the transmitting apparatus; and
flipping, by the receiving apparatus, the pre-shared authentication key by using the channel gain information and authenticating the transmitting apparatus by using a flipped second authentication key.

2. The method of claim 1, wherein in the authenticating of the transmitting apparatus, the transmitting apparatus is authenticated based on a magnitude of a calculation value calculated by computing the flipped second authentication key and the second signal.

3. The method of claim 2, wherein in the authenticating of the transmitting apparatus, the transmitting apparatus is authenticated by comparing the magnitude of the calculation value and a threshold value.

4. The method of claim 3, wherein in the authenticating of the transmitting apparatus, the threshold value is determined by calculating a probability density function for the magnitude of the calculation value.

5. The method of claim 4, wherein in the authenticating of the transmitting apparatus, result values of two probability density functions for the magnitude of the comparison value are calculated based on a condition that the second signal will be a signal by the transmitting apparatus and a condition that the signal for requesting the authentication will be a signal by an attacker.

6. The method of claim 5, wherein in the authenticating of the transmitting apparatus, the result values of the two probability density functions are estimated through a Monte-Carlo simulation based on a Rice distribution.

7. A transmitting apparatus for authenticating a signal by using channel gain information, the transmitting apparatus comprising:
a channel gain estimating unit estimating channel gain information for a receiving apparatus by using a first signal received from the receiving apparatus; and
an authentication requesting unit flipping an authentication key pre-shared with the receiving apparatus by using the channel gain information and requesting authentication by transmitting a second signal to respond to the first signal to the receiving apparatus by using a flipped authentication key.

8. A receiving apparatus for authenticating a signal by using channel gain information, the receiving apparatus comprising:
a channel gain estimating unit estimating channel gain information for a transmitting apparatus by using a signal for requesting authentication, which is received from the transmitting apparatus; and
an authentication performing unit flipping an authentication key pre-shared with the transmitting apparatus by using the channel gain information and authenticating the transmitting apparatus by using a flipped authentication key.

9. The receiving apparatus of claim 8, wherein the authentication performing unit authenticates the transmitting apparatus based on a magnitude of a calculation value calculated by computing the flipped authentication key and a signal for requesting the authentication.

10. The receiving apparatus of claim 9, wherein the authentication performing unit authenticates the transmitting apparatus by comparing the magnitude of the calculation value and a threshold value.

11. The receiving apparatus of claim 10, wherein the authentication performing unit determines the threshold value by calculating a probability density function for the magnitude of the calculation value.

12. The receiving apparatus of claim 11, wherein the authentication performing unit calculates result values of two probability density functions for the magnitude of the comparison value based on a condition that the signal for requesting the authentication will be a signal by the transmitting apparatus and a condition that the signal for requesting the authentication will be a signal by an attacker.

13. The receiving apparatus of claim 12, wherein the authentication performing unit estimates the result values of the two probability density functions through a Monte-Carlo simulation based on a Rice distribution.
